(19) United States
(12) Patent Application Publication
(10) Pub. No.: US 2002/0156896 A1
(43) Pub. Date: Oct. 24, 2002

(54) System and method for providing a gateway between mobile two-way messaging devices and remote computer networks

(76) Inventors: Peter Lin, Worcester, MA (US); Tilak Doddapaneni, Northbrook, IL (US)

Correspondence Address: Jones, Day, Reavis & Pogue, 51 Louisiana Avenue, N.W., Washington, DC, 20001-2113, US

(21) Appl. No.: 09/781,912

(22) Filed: Feb. 9, 2001

(51) Int. Cl. G06F 15/16

(52) U.S. Cl. 709/227; 709/203

(57) ABSTRACT

The disclosed invention comprises a system and method for providing two-way content communication between wireless mobile communication devices, such as pagers and Personal Information Managers, and a remote computer network such as the Internet. The system includes a wireless two-way messaging network and an intermediary computer network in communication with the remote computer network. The wireless two-way messaging network employs a network and layer framework, preferably programmed in the wireless mobile device, that includes a system layer, an operating system layer, a user interface, and a Message Transport Protocol (MTP) stack.

The method for providing two-way content communication between wireless mobile communication devices and a remote computer network include originating a data request at the mobile communication device, transmitting the request via a queue to the intermediary computer system, retrieving the requested data from the remote computer system, and transmitting the retrieved data to the wireless mobile communication device via the wireless two-way messaging network. In the preferred embodiment, the retrieved data is transformed to an intermediary markup language, preferably Extensible Markup Language (XML), validated for MTP coding and transmission completeness, analyzed for type of data, and transformed to a target markup language. The validated, analyzed and transformed data is subsequently displayed at the mobile communication device in a suitable form, which in a preferred embodiment is a browser with a graphical user interface.

Data encryption and decryption is available for all data transmission in the present invention, and the system and method include means for placing all transmitted data into packets of maximum 448 characters, suitable for Short Messaging Service protocol and similar protocols.

### FIELD OF INVENTION

The present invention relates to a method and computer system providing an improved interface between remote networks and mobile devices. In particular, the present invention relates to wireless network gateways for mobile devices with two-way short messaging and email capabilities utilizing an improved messaging transport protocol and intermediary computer system. The intermediary computer system features applications for message validation, data retrieval and transformation, security and other features that facilitate interactive communication between remote networks and simple two-way messaging mobile devices.

### BACKGROUND

The Internet is an international system of computer networks, comprised of a series of computers interconnected by means of data lines, routers and/or wireless communication links. Each computer, as part of the Internet, serves amongst other things as a storage device for data flowing between computers. The Internet facilitates data interchange, as well as remote login, electronic mail (“email”), and newsgroups. One integral part of the Internet is the World Wide Web (“the Web”), a computer-based network of information resources. The Internet is also a transmission medium for emails. Other uses of the Internet are Telnet, File Transport Protocol (“FTP”) and Gopher. Telnet allows remote computer access and usage (remote log-in), whereas FTP and Gopher represent methods of moving files from one computer to another via the Internet notwithstanding different operating systems or storage formats.

Like all computer networks, the Internet operates within the client-server format. Servers are typically remote computer systems that store and transmit documents over the network to other computers upon request. Clients are any computer systems or other interactive devices that receive information from a server. A client may be a personal computer or a wireless device such as a handheld, a cellular phone or any other Internet-enabled mobile device that is capable of two-way communication.

All data transmitted over the Internet is broken down into small units of data called packets. Each packet is assigned a unique number which is later used to re-assemble the data packets when they arrive at their destination. For this reason, the Internet is also called a packet-switched network. The series of protocols used to achieve packet-switching is Transmission Control Protocol/Internet Protocol (“TCP/IP”). This system contrasts with circuit-switched networks in which the communication circuit (path) for the session is set up and dedicated to the participants in that session. An example for such a circuit switched connection is a land line phone call.

In order to standardize the communication between servers and clients on the Internet, additional protocols that are usually packaged with TCP/IP are used for the transmission of data. As known in the art, network communication is based on the seven layer model Open System Interconnection (“OSI”). Information being transferred from a software application in one communication system to another, e.g., from one computer to another via the Internet, must pass through each of the OSI layers. Each layer handles a different task in the information exchange process and the actual information exchange occurs between peer OSI layers. Each layer in the source system ads control information to the transmission data and each layer in the destination system analyzes and removes the control information from that data. At the lowest layer, the physical layer, the entire information packet is placed onto the network medium where it is picked up by the receiving unit. In this model, protocols represent and describe the formal rules and conventions that govern the exchange of information over a network medium. The protocol likewise implements the functions of one or more of the OSI layers. The transport protocol for Web sites is Hyper Text Transfer Protocol (“HTTP”), for emails Simple Mail Transfer Protocol (“SMTP”) and for software programs FTP. Simple Network Paging Protocol (“SNPP”) is a protocol designed to bridge pager networks with the Internet. Premised on the functions of the used network layers to be implemented and the tasks to be achieved during the communication, protocols vary in their specifications. Many more protocols than the few mentioned above exist.

Web sites are formatted in Hyper Text Markup Language (“HTML”), Wireless Markup Language (“WML”) or Extensible Markup Language (“XML”). These are standard text formatting languages for interconnected networks such as the Internet. So called Web browsing software interprets HTML, WML, and/or XML documents, thereby allowing users to view Web sites on their display screen. As is the case with protocols, additional languages exist for the marking-up of Web Sites or other data.

When accessing the Internet by use of a wireless device, the data link is established via a wireless modem or an antenna and a wireless carrier service using radio frequencies, rather than via twisted-pair or fiber-optic cables. Content for wireless devices is marked up in WML, rather than HTML. One of the possible wireless transfer protocol is Wireless Application Protocol (“WAP”), rather than HTTP. For that reason wireless devices cannot directly communicate with Internet servers. Yet, there is a growing demand for wireless Internet access and browsing capabilities of wireless devices. Therefore, a system and method for improved data transformation and transmission is needed that serves as an intermediary gateway between the wireless device and the Web or other parts of the Internet.

Another problem to be confronted with wireless devices, is their limited processing power and memory resources. Even if the wireless device featured browsing software capable of interpreting HTML documents, the limited resources of the handheld would result in data latency, both in transmission and interpretation of the downloaded document.

A third problem is that even though several wireless communication devices, such as cellular phones, pocket PCs and other personal digital assistants are already Internet-enabled, no such applications yet exist for two-way pagers. Short messaging services (“SMS”) provide transmission of text messages, but until recently pagers could not respond to sent messages. There are several SMS networks, for example TAP, ETAP, Flex and ReFlex. The transfer protocols used are Telocator Alphanumeric Protocol (“TAP”), Enhanced Telocator Alphanumeric Protocol (“ETAP”), Simple Network Paging Protocol (“SNPP”) or Simple Mail Transfer Protocol (“SMTP”). Nowadays, pagers are not only capable of receiving signals and short messages, but by use of radio modems so called two-way pagers allow the user both to receive and send data. These new developments make two-way pagers capable of intelligent two-way interactions not only among pagers, but also between pagers and networks, such as the Internet. However, pagers cannot accept multi-part messages on account of a 500 character per message limit established by the ETAP standard. Since Web sites and other content records usually consist of far more characters and tags, display on pagers is impeded. Further, due to their limited storage and processing resources, off-shelf pagers cannot display data encoded in HTML or WML. Currently, no applications or technology exists providing server client communication between pagers and computer networks. Experiments have been undertaken where data is sent back and forth between pagers and remote computer systems or networks using email filters. However, the latter require a user to create an email account and the use of additional filters and scripts on an intermediary unix email server. Additionally, such data transactions are not scalable and do not facilitate development of client-server applications. Other business models, such as Skytel, allow the user to choose between several information messaging services, e.g., weather or stock news, but do not allow data retrieval requests that originate with the pager.

Further, pager networks are not ideally suited for interactive communications because they typically merely store and forward data from one location to another and therefore were designed for one-way communication. Since data retrieval transactions with remote networks require constant interactive and multi-packet communication, there is a need for secure and stable connections. Pager networks, however, are packet-switched and thus use shared resources for the communications, rather than dedicated lines of communication. Additionally, the particularities of radio frequency transmission and the slow data transfer rate of pager networks impede interactive transactions. The data transmission rate for pagers ranges from 9,600 to 28,800 baud, whereas the data rate may be dramatically lower than 9,600 baud on account of the quality of the radio signal.

Last, pagers are currently incapable of reassembling the pieces of a multi-part message into one collated object. For the latter reason the display of data content records consisting of several multi-packet transmission on pagers is currently not possible.

### OBJECTS OF THE INVENTION

It is therefore an object of the present invention to provide a system and method that enables two-way interaction between interactive mobile devices and computer networks.

It is another object of the present invention to enable data retrieval from computer networks and display it on the interactive mobile device, while overcoming impediments such as distinct transfer protocols and mark-up languages.

It is yet another object of the present invention to enable such interaction without the necessity of creating an email account on an intermediary system.

It is still another object of the present invention to outsource browsing features, data transformation and retrieval, as well as other data management features from the mobile device to an intermediary server in order to prevent data latency in transmission and interpretation of downloaded data from computer networks to the two-way messaging device and to save storage resources.

It is yet another object of the present invention to provide a messaging protocol that enables division of data packets into multiple 500 character pieces and re-assembly of the data pieces after transmission, while validating the accuracy and completeness of the transmitted data for two-way message messaging devices.

It is still another object of the present invention to mimic circuit-like connections from simple two-way messaging devices to computer networks in order to facilitate secure and stable browsing sessions.

### BRIEF DESCRIPTION OF THE DRAWINGS

FIG. 1 illustrates a system enabling two-way interactive communication between mobile devices and a remote network according to one of embodiment of the present invention.

FIG. 2 illustrates a computer system in which the present invention can be implemented according to one embodiment of the present invention.

FIG. 3 illustrates a remote network environment comprising the Internet, local area networks (LANs), and intranets in which the present invention can be implemented.

FIG. 4 illustrates the system architecture of a two-way messaging network in which the present invention can be implemented according to one of its embodiments.

FIG. 5 illustrates the software and layer frame work of a simple two-way messaging device in which the present invention can be implemented according to one of its embodiments.

FIG. 6 represents a flow chart illustrating the process and method of transmitting a data request from the simple two-way messaging device to the intermediary computer system according to one embodiment of the present invention.

FIG. 7 represents a flow chart illustrating the process and method of managing and responding to a data request originating with the two-way messaging device by the intermediary computer system according to one embodiment of the present invention.

FIG. 8 represents a flow chart illustrating the process and method of final data management and display of the transmitted data at the two-way messaging device according to one embodiment of the present invention.

### SUMMARY OF THE INVENTION

The present invention is directed to a system and method for providing a gateway for mobile devices to access, browse and retrieve data from remote computer networks. The present invention particularly enables users of simple two-way messaging devices to establish a connection to and retrieve data from remote computer networks using simple email or SMS stacks as transport layers. It does not require the creation of an e-mail account, additional filters or scripts. A user may request data from a remote computer network utilizing a particular messaging protocol that encodes the request and establishes a circuit-like connection to a computer system acting as an intermediary between the mobile device and the computer network. The intermediary computer system manages the user's session, retrieves the requested data from other remote computer systems, translates and transforms the data into a format that can be interpreted by the mobile device. The messaging protocol used allows the encoding and division of the retrieved data into 448 character pieces. These 448 character data packages are transmitted sequentially or simultaneously to the mobile device until transmission is complete. The messaging protocol stack on the mobile device validates, re-assembles and collates the transmitted data into one object for display. After completion of the communication session, the intermediary computer system destroys the cached session data and returns the resources back to the resource pool.

### DETAILED DESCRIPTION OF THE INVENTION

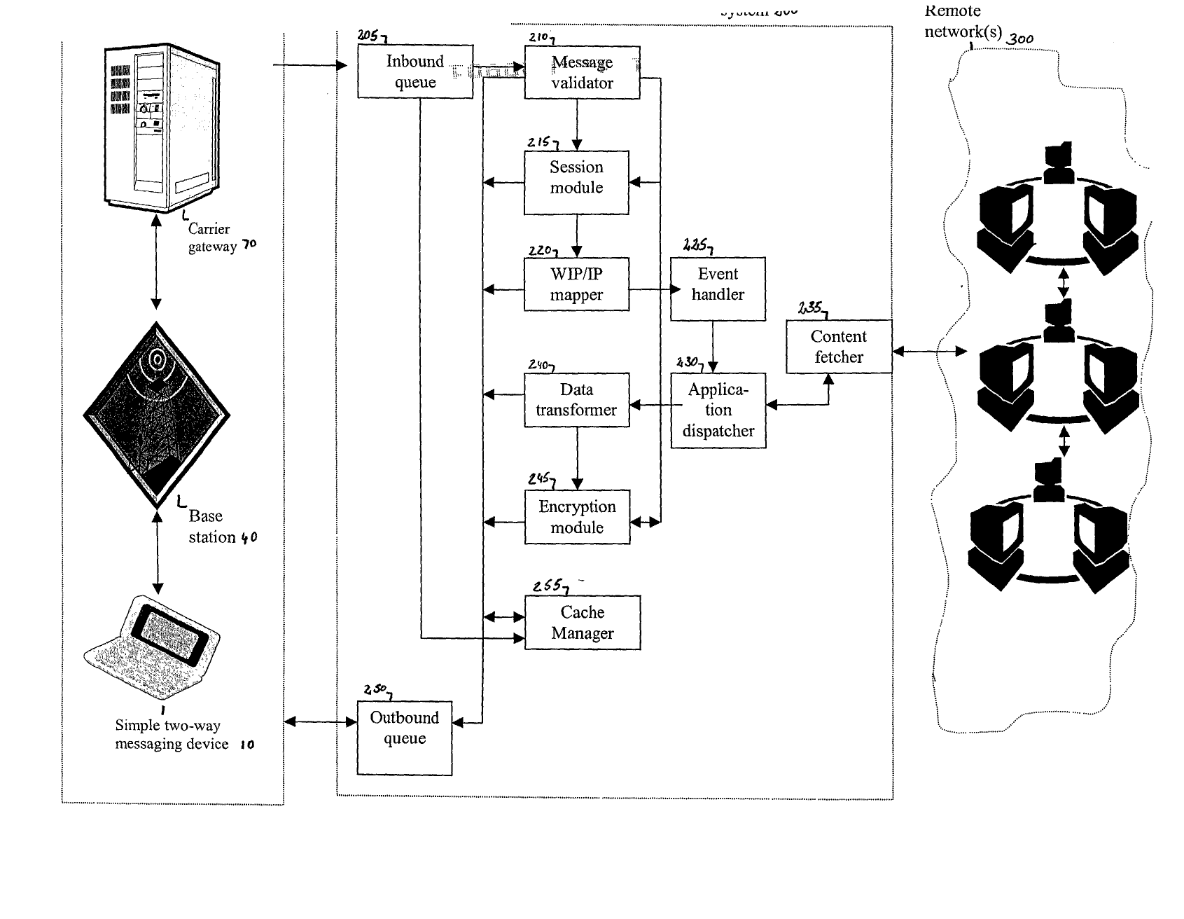

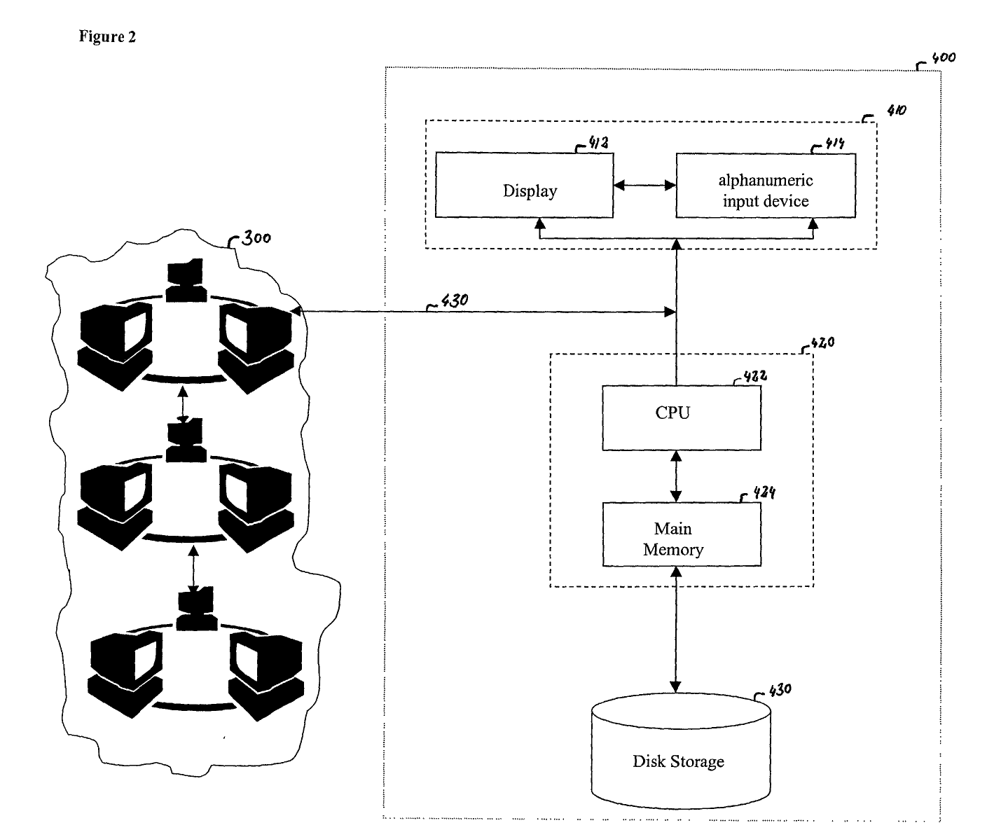

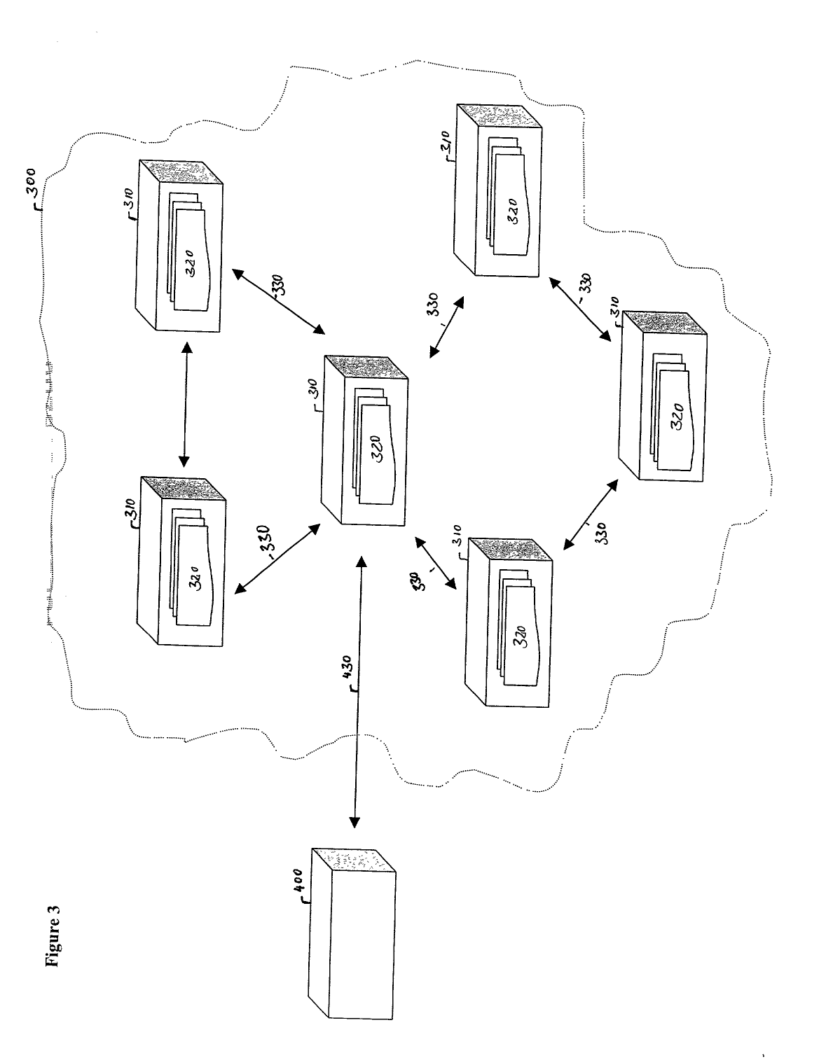

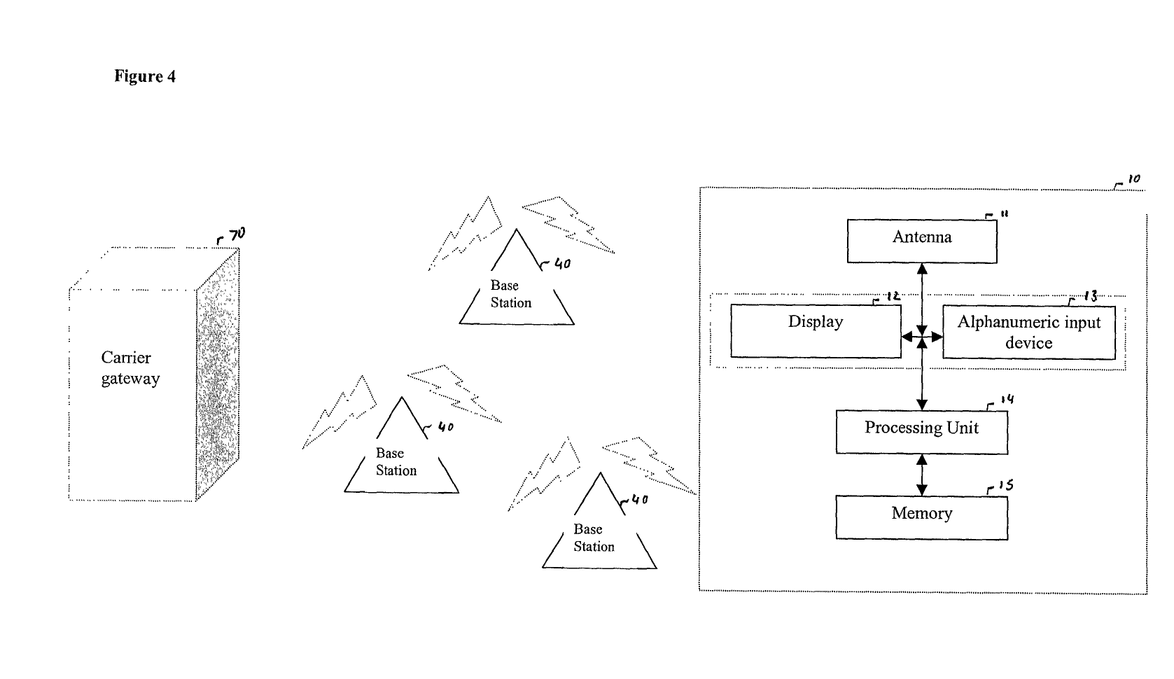

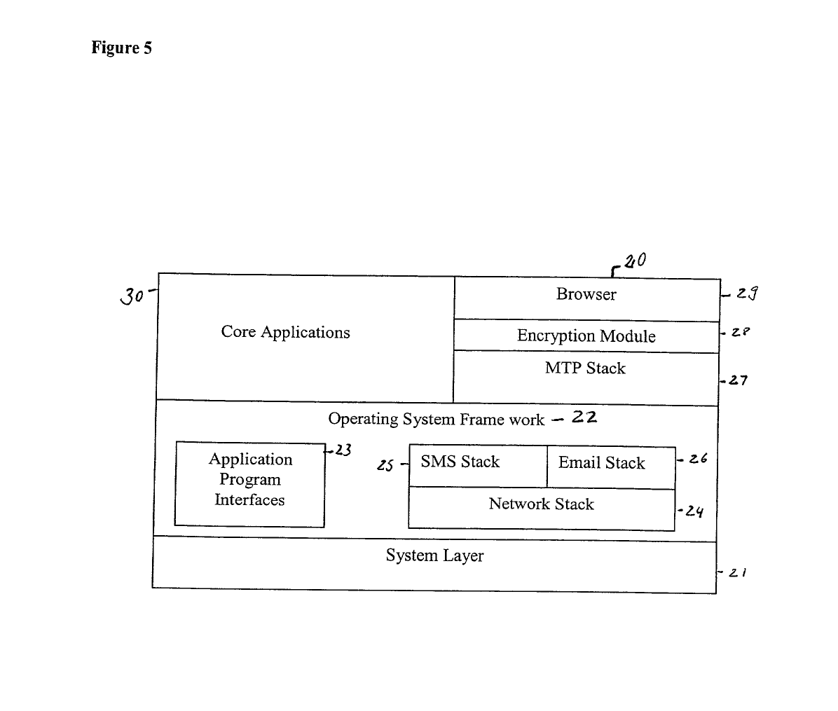

FIG. 1 illustrates a system enabling interactive real-time communication between a simple two-way messaging device and a remote network according to one embodiment of the present invention. FIG. 1 illustrates a client simple two-way messaging network 100 consisting of a two-way messaging device 10 (described in FIGS. 4 and 5), coupled to a carrier gateway 70 via base station 40. Via a wireless data link, simple two-way messaging network 100 communicates with one or several server computer system(s) 200 which may be a regular computer system 400 as described in FIG. 2. Intermediary computer system 200 is coupled to a remote network 300 (FIG. 3), such as the Internet. The server system 200 in the preferred embodiment of the present invention consists of an inbound queue 205, a message validator 210, a session module 215, a WIP/IP mapper 220, event handler 225, application dispatcher 230, content fetcher 235, data transformer 240, encryption module 245, outbound queue 250 and cache manager 255. As is well known by those of ordinary skills in the art, the various components on server system 200 may be implemented on separate computer systems 400 or on one single computer system 400 running the separate components simultaneously or sequentially. Likewise, the various databases in WIP/IP mapper 220, application dispatcher 230, data transformer 240, encryption module 245 and cache manager 255 may be stored on the same or separate computer systems 400. Simple two-way messaging network 100 interacts with the intermediary computer system 200 via the inbound queue 205 and outbound queue 250. Inbound queue 205 communicates with message validator 210 and cache manager 255. Message validator 210 communicates with the outbound queue 250 and session module 215, which in turn communicates with WIP/IP mapper 220 and outbound queue 250. WIP/IP mapper 220 also corresponds with event handler 225 and outbound queue 250. Application dispatcher 230 interacts with content fetcher 235 and data transformer 240. Content fetcher 235 interacts with remote network(s) 300 and application dispatcher 230. Data transformer 240 communicates with outbound queue 250 and if requested with encryption module 245. Encryption module 245 likewise corresponds with outbound queue 250. Outbound queue 250 communicates with simple two-way messaging network 100 and cache manager 255.

FIG. 2 illustrates a computer system 400 in which the present invention, and in particular intermediary computer system 200, can be implemented according to one embodiment of the present invention. Computer system 400 consists of an input/output system 410, a system unit 420 and a disk storage 430. The input/output system comprises a display 412 and an alphanumeric input device 414 (e.g., keyboard or keypad). The system unit 420 includes a central processing unit (“CPU”) 422 and a main memory 424. Disk storage device 430 is coupled to the system unit 420, which in turn is coupled to the input/output system 410. The system unit 420 may additionally be coupled via a data communication link 430 to remote network(s) 300, such as the Internet. The disk storage 430 generally stores operating instructions and data for the computer system 400. Operating instructions are retrieved from disk storage 430 and stored in main memory 424. Then, the CPU 422 retrieves specific instruction from main memory 424 and executes them as specified. Data required in the execution of the instructions is also retrieved from disk storage 430 into main memory 424. Via communication link 430, instructions or data may likewise be retrieved from remote storage devices such as computer systems 400 that may be part of remote network(s) 300, such as the Internet, a LAN, or an intranet.

FIG. 3 illustrates remote network(s) 300 comprising the Internet, LANs and intranets. The part of the Internet that allows transfer of data files in HTML, XML or WML is the World Wide Web consisting of millions of Web sites. In general, the Internet consists of a plurality of servers 310. As is well known by those skilled in the art, the servers 310 may be computer systems 400 as described in FIG. 2. Each of the servers 310 is accessible via cable or wireless data links by a client computer system 400 or other interactive devices 10, such as those of the type described in FIG. 4. Each of the servers 310 may communicate with other servers 310 through communication link 330. Each server 310 stores a plurality of files 320. These files 320 may contain Web site records, software or other data. In the emerge of greater mobility users are particularly interested in locating and downloading files 320 of interest on mobile devices via wireless data links. The present invention assists the users of simple two-way messaging devices 10 both in the process of locating and retrieving data in a compatible format without exhausting the device's limited memory resources.

FIG. 4 illustrates the system architecture of a simple two-way messaging network 100 in which the present can be implemented according to one embodiment of the present invention. The two-way messaging network 100 comprises a simple two-way messaging device 10, such as a two-way pager, several base stations 40 and a carrier gateway 70. By interaction of the several components of the simple two-way messaging network 100, the user of a two-way messaging device 10 may communicate either with other two-way messaging devices 10 or by use of the present invention even with servers 310 on remote network(s) 300, such as the Internet. The simple two-way messaging device 10 in the preferred embodiment of the present invention consists of an antenna 11, a display 12, an alphanumeric input device 13, such as a miniature keyboard, a processing unit 14 and a memory 15.

Antenna 11 allows the two-way messaging device 10 to both receive and transmit messages encoded in radio signals. The decoding of the signals is achieved by processing unit 14 which can pass the message onto display 12 and/or store it in memory 15. Those skilled in the art will be aware that there are additional features that can be implemented in the input/output device, such as a beeper, a vibrator, a toggle or pushbutton switch. Memory 15 stores an operating system and other data that can be retrieved and executed by the processing unit 14. The present invention enables the user of a two-way messaging network 100 to likewise retrieve and display data files 320 from remote servers 310, e.g., from network(s) 300 such as the Internet. The alphanumeric input device 13 of two-way messaging device 10 enables the user to input data requests, which is encoded into radio signals by processing unit 14 and communicated to antenna 11. The transmitting section of antenna 11 transmits the radio signals via radio base stations 40 to a carrier gateway 70. The carrier gateway 70 forwards the incoming traffic to the designated destination. Upon manufacture each simple two-way messaging device 10 is assigned a unique alphanumeric number, which is stored in memory 15 and used to identify the respective device 10. This identifier is also known as Wireless IP (“WIP”).

Those skilled in the art will recognize that the system architecture of device 10 approximates that of computer system 400 (FIG. 2). Both the two-way messaging device 10 and computer system 400, as well as other devices can be implemented as clients in the client-server architecture of networks. In the present invention, the two-way messaging device 10 represents a client.

FIG. 5 illustrates the software and layer frame work 20 of a simple two-way messaging device 10 such as a two-way pager in which the present invention can be implemented according to one of its embodiments. The system framework of simple two-way messaging device 10 as part of a simple two-way messaging network 100 consists of hardware components as described in FIG.4, and of software and network layers that are implemented into the hardware components as described in the following.

As explained in the background, data transmission from one communication system to another via a network requires data flow through each of the involved network layers on the source system down to the physical link where it is passed on to the peer physical link of the destination system. There, the data packet is picked up and flows through the involved peer layers of the destination system before it can be viewed on the recipient's display by use of a software application, such as a browser. The utilized protocols implement the necessary functions of the involved layers and sets the rules that govern the communication between the source and destination system.

In general, the same communication concept applies to the simple two-way messaging devices 10, as used in the preferred embodiment of the present invention: the lowest layer is represented by system layer 21 at the electrical and mechanical level where the hardware is handled, the data bit stream is synchronized and conveyed by a radio frequency carrier signal. Implemented on top of system layer 21 is operating system framework 22 that includes application program interfaces (“APIs”) 23, which serve as interfaces for core applications 30 and other applications, such as a possible browser 29. On the same level as the APIs 23, a network stack 24, and on top of it an SMS stack 25 and email stack 26 are embedded. A stack is defined as a bundle of layers necessary for network communication, and through which all data passes at both ends of the data communication systems. Thus, the network stack 24 is responsible for the sending and receiving of the transmitted data. SMS stack 25 manages the transmission of short messages, and email stack 26 handles the transfer of emails. On top of the operating system framework 22 with its APIs 23, network stack 24, SMS stack 25 and email stack 26 sit the core applications 30 which may consist of encryption module 28, an address book application, and an email program.

The aforementioned layers and software components 21, 22, 23, 24, 25, and 26 are usually pre-implemented on the simple two-way messaging device 10 upon manufacture. Yet, this is not the case with encryption module 28, browser 29 and MTP stack 27. Message Transport Protocol stack (“MTP”) 27 that is shown in the diagram as built on top of the operating system framework is a core component of the present invention. The MTP stack 27 is responsible for creating connections between the simple two-way messaging network system 100 and intermediary computer system 200 (FIG. 1), deciding which intermediary computer system 200 to contact, MTP encoding of the message body in order to denote a data packet as an MTP packet, mimicking of circuit connections in order to facilitate seamless communication by inspecting incoming messages for proper MTP encoding, integrity and completeness, and collating multi-part messages into one object and passing the latter to an application (such as browser 29). Also, the MTP stack 27 removes old messages in order to save the limited memory resources of the simple two-way messaging device 10. If the device features sufficient memory resources, the MTP stack 27 may create secure connections by encrypting the messages using encryption module 28. The MTP stack 27 implements a Messaging Transfer Protocol (“MTP”) which describes the rules for encoding, passing connection information and managing connections.

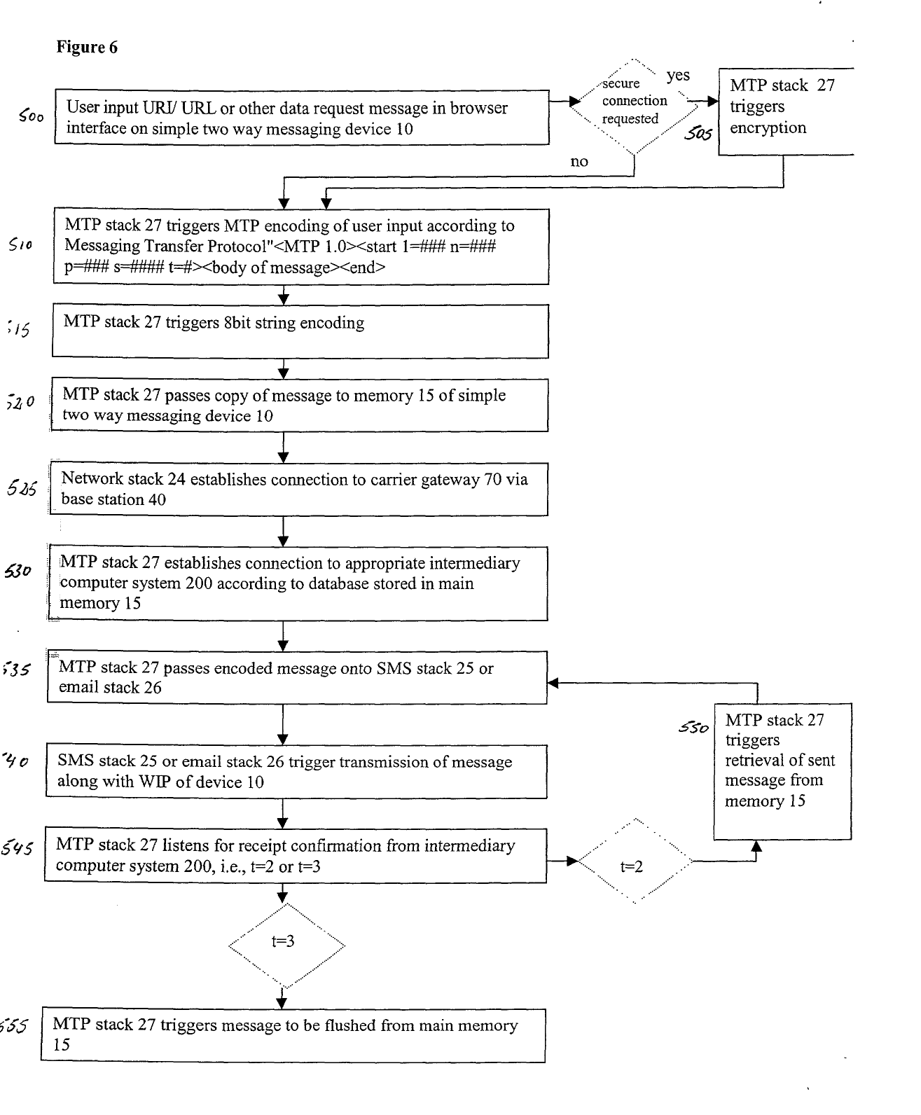

The details of the interaction between the MTP stack 27 and the intermediary computer system 200, in particular the process of retrieving data from remote network(s) 300 by use of the present invention is explained in more detail in FIG. 6. Browser 29 may serve as an input tool of Unique Resource Indicators (“URIs”), and Unique Resource Locators (“URLs”) in particular for the process of data retrieval from remote network(s) 300. URLs serve as generic resource indicators, whereas URLs are primarily associated with Web servers.

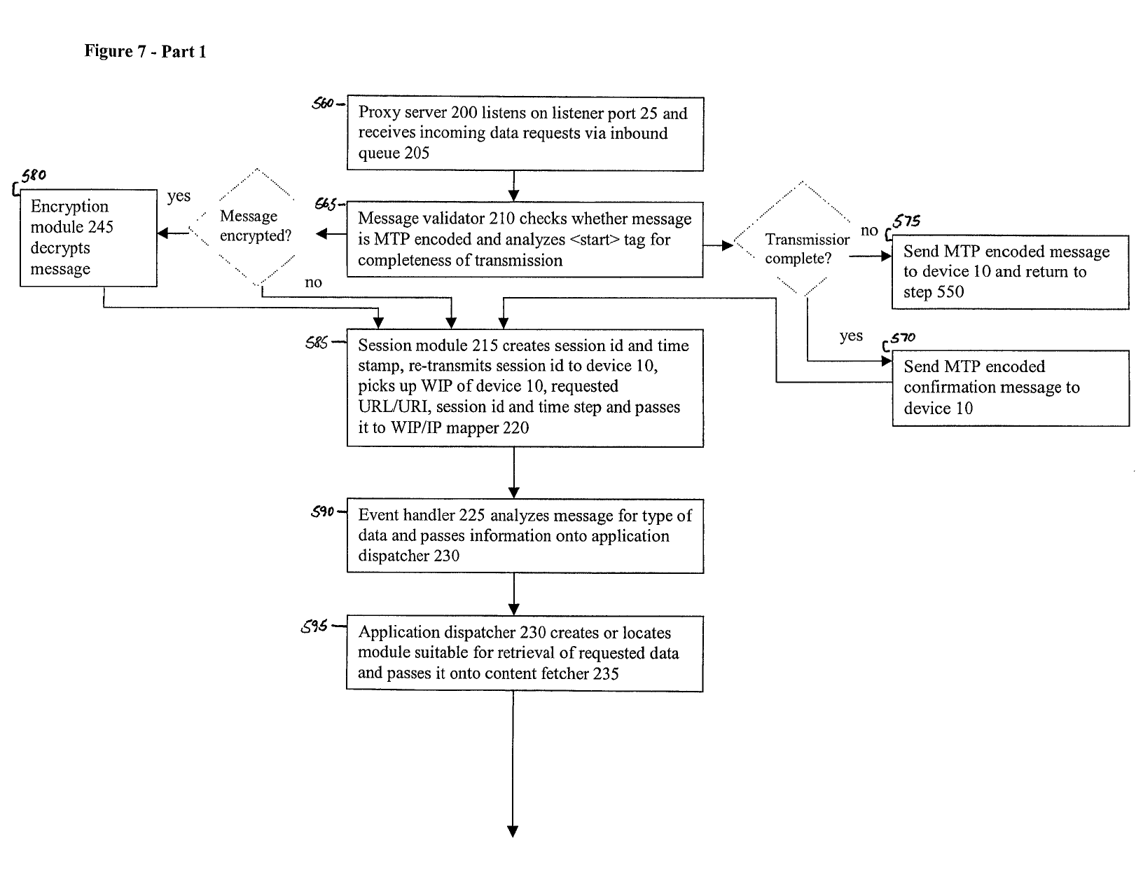

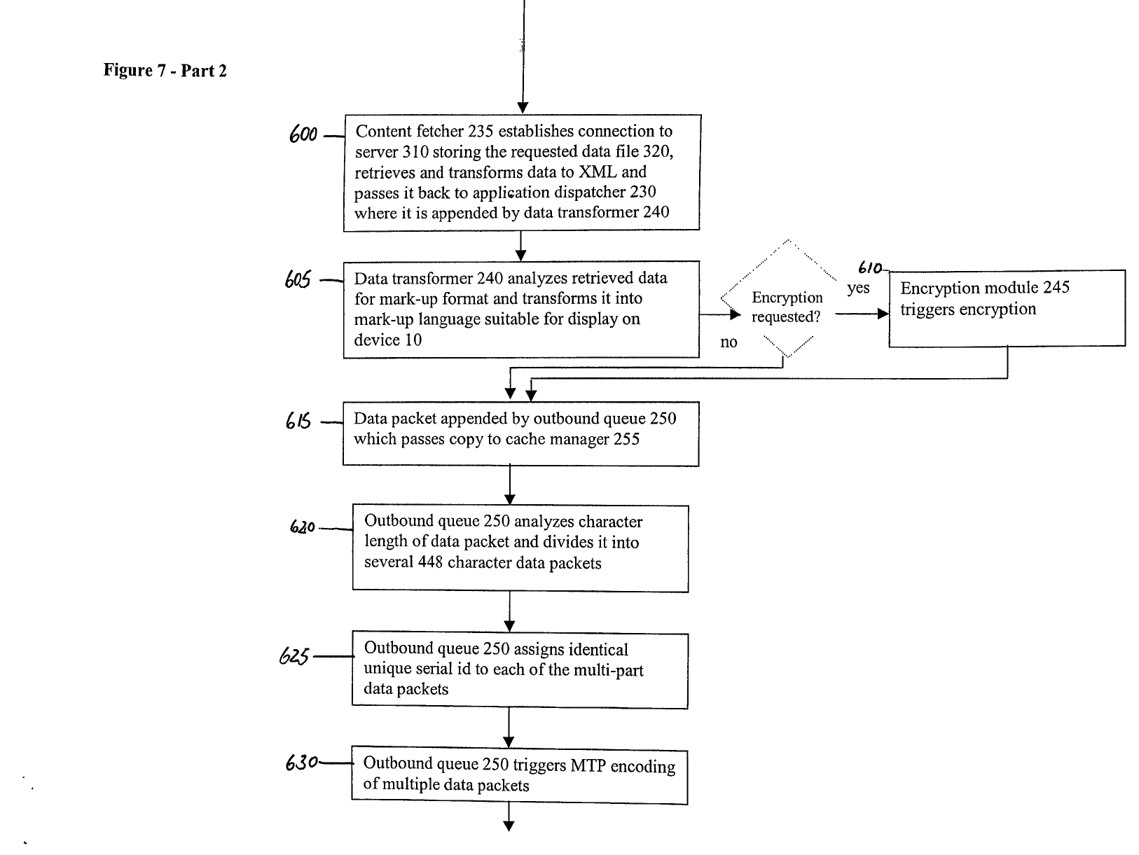

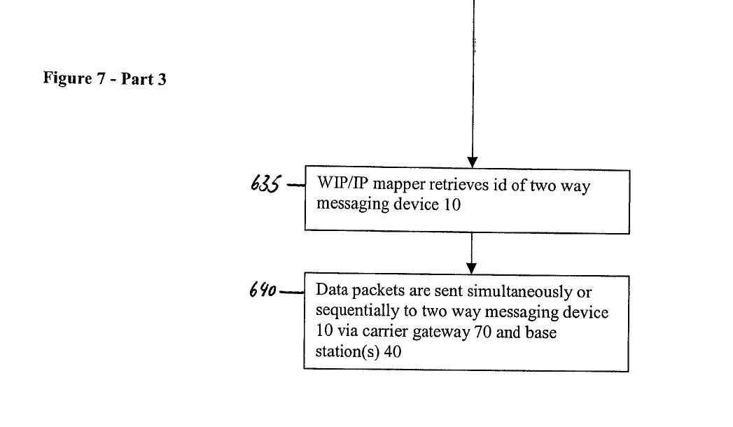

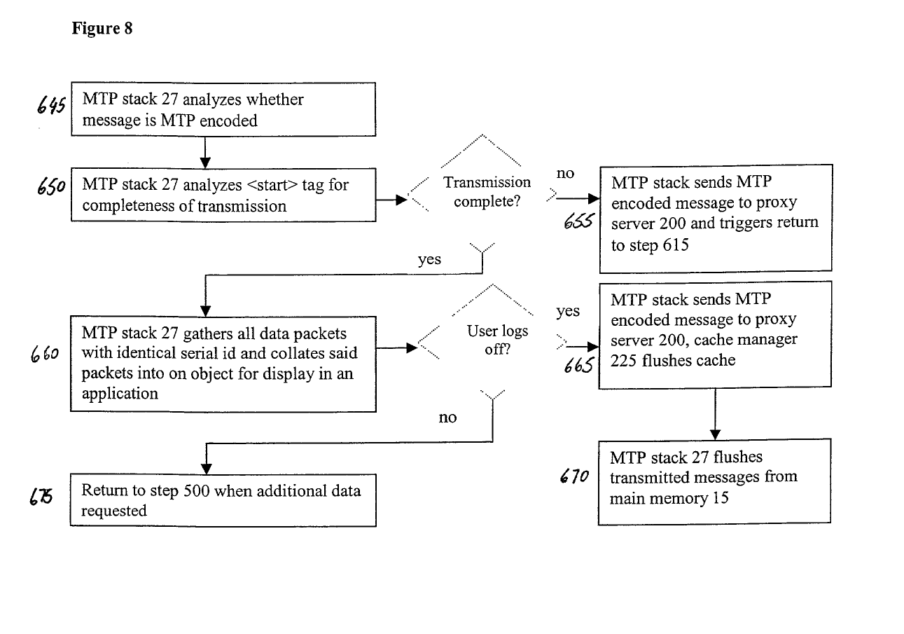

FIG. 6 illustrates the process and method of transmitting a data request from the simple two-way messaging device 10 to the intermediary computer system 200 according to one embodiment of the present invention. The two-way messaging device 10 serves in this process as a client, the intermediary computer system 200 as a server 310 communicating with other servers 310 for retrieval of data files 320 and re-transmission to device 10. The process of data retrieval by use of one embodiment of the present invention is broken down into three parts: The first part, the data request originating from device 10, is described as follows in FIG. 6; the process and method of data retrieval, transformation and transmission by intermediary computer system 200 is illustrated in FIG. 7; and the third part of the final data managing and display at the two-way messaging device 10 is explained in FIG. 8.

At step 500 the process starts when the user of a simple two-way messaging system 10, such as a two-way pager inputs a data request via the device's alphanumeric input device 13, e.g., by input of an URL. Preferably, a browser 29 may be used for such input of a data request. It is understood that data requests may likewise be initiated by any other appropriate software applications on the two-way messaging device 10. By way of example, a user may request the addresses of movie theaters located within 20 miles of the user's residence from a Web Site with the URL http://www.moviefone.com.

If the simple two way messaging device features an encryption module 28, the user may chose to establish a secure session. If yes, the MTP stack 27 triggers at step 505 the encryption of the message body by use of the well known Secure Socket Layer protocol (“SSL”) or any other featured encryption technology. If the user does not request a secure connection, the present invention will directly proceed to 510.

At step 510 the MTP stack 27 triggers the encoding of the data request message into Messaging Transfer Protocol. In order to qualify as a MTP data packet and according to the MTP specifications, the body of the message must begin with “<MTP 1.0>”, immediately followed by the tag “<start>”. The message end is indicated by the “<end>” tag. The MTP stack 27 is likewise capable of transmission error handling and therefore includes in the start tag a list of properties to facilitate error and parity checking when the message is received by the intermediary computer system 200. The error handling process allows the establishment of stable connections and thereby also facilitates the mimicking of circuit-like connections for seamless data transfers. The list of properties in the MTP start tag is defined as follows: <start 1=#### n−## p=## s=##### t=#>. Whereas “1” equals the length of the message embedded between the tags <start> and <end>. The maximum length of a message is 448 characters since the existing network services for simple two-way messaging devices 10, such as two-way pagers, limit the number of characters per message to 500. After subtraction of the protocol related 52 characters for the tags, the message may not exceed 448 characters. The length of the message is indicated by a three digit value, e.g., 001, 002 . . . 448. “n” represents the number of pages , “p” the page number, both in a two digit format. “s” identifies the packet serial id indicated by a five digit value. This is relevant for data packages that exceed 448 characters and must therefore be broken down into multi-part 448 character data packets. Each of these data packets is assigned the same serial id in order to later collate the whole package into one data object. “t” represents the status of transmission, respectively a command to the two-way messaging device 10 or intermediary computer system 200. “t” is expressed in a one digit format associated with three possible values, whereas “0” equals “new”, “1” equals “send”, 2 equals “resend” and 3 equals “flush”.

In the present example, if the user chooses not to encrypt the message, the MTP encoded message sent by the two-way messaging device 10 would be: <MTP 1.0><start 1=041 n=01 p=01 s=1111 t=0><http>get http://www.moviefone.com</http></end>. Whereas the value “041” associated with “1” indicates that the embedded message “<http>get http://www.moviefone.com</http>” consists of 41 characters, the value “01” associated with “n” and “p” stands for “1 page” and “page number 1”, the value “11111” associated with “s” denotes the serial id, and the value “0” associated with “t” specifies the status of the message transmission, i.e., “send”.

MTP does not encode the content of the message itself since Internet mark-up languages change and evolve rapidly, and it would therefore not be beneficial to include such details in the Messaging Transfer Protocol.

At step 515, MTP stack 27 triggers 8bit string encoding which is the standard for character encoding in simple two messaging networks 100, such as two-way pager networks. Then, at step 520, the MTP stack 27 passes a copy of the MTP encoded message to memory 15 of the simple two-way messaging device 10. This step becomes relevant later in the process if the transmission of the message is incomplete or corrupted. At step 525, the network stack 24 of the simple two-way messaging device 10 establishes a connection to the carrier gateway 70 through one of the base stations 40. At step 530, the MTP stack 27 checks whether there is a specific intermediary computer system 200 that complies with the data request from step 500. By way of example, there may be several computer systems 200, whereas each of the latter may communicate with specific servers 310 in order to facilitate and accelerate retrieval of data files 320. The information as to which intermediary computer system 200 communicates with which server 310 may be stored in memory 15 of the messaging device 10. According to this information, the MTP stack 27 establishes a connection with the appropriate intermediary computer system 200 or if no such information is available establish a connection with a default intermediary computer system 200. Then, at step 535, the MTP stack 27 passes the MTP encoded message to the SMS stack 25 or email stack 26.

At step 540, SMS stack 25 or email stack 26 trigger the transmission of the message and send along the WIP of device 10 to the intermediary computer system 200. After the transmission, at step 545, the MTP stack 27 listens for a confirmation from the intermediary computer system 200. This receipt message is likewise MTP encoded, i.e., the status of the transmission is indicated by the “t”-value in the MTP <start> tag, and specifies a command for the receiving system, here the two-way messaging device 10. If the transmission was corrupt, the value of “t” of the receipt message equals “2” (“resend”).

In the example, the following message would be transmitted from the intermediary computer system 200 to the two-way messaging device 10: <MTP 1.0><start 1=000 n=01 p=01 s=11111 t=2></end>.

Consequently, the MTP stack 27, at step 550, triggers the retrieval of the transmitted message from memory 15 and returns to step 535 in order to re-send the message. If the transmission is complete, the “t” value equals “3” (“flush”), and the MTP stack 27 triggers the message to be flushed from memory 15 of device 10 at step 555.

In the example, the following message would be transmitted from the intermediary computer system 200 to the two-way messaging device 10: <MTP 1.0><start 1=000 n=01 p=01 s=11111 t=3></end>.

If the two-way messaging device 10 does not receive any message from the intermediary computer system 200 at all, it will display a message indicating that the system is unavailable.

FIG. 7 illustrates the process and method of managing and responding to data requests as described in FIG. 6 by the intermediary computer system 200 according to one embodiment of the present invention. Intermediary computer system 200 is of the type of computer system 400 as described in FIG. 2 and may be part of remote network(s) 300. It is publicly accessible and capable of interactive communication with other servers 310 through the network protocol TCP/IP. Intermediary computer system 200 represents the server in the network architecture of the preferred embodiment present invention, and may likewise be described as a proxy server, i.e., a server that acts on behalf of the client and communicates with other servers 310. Such other servers 310 may be FTP file servers, SMTP email server, HTTP Web servers or SQL (“Structure Query Language”) database servers. The intermediary computer system 200 is built on top of a SMTP compliant server, since the simple two-way messaging device 10 transmits MTP encoded messages using an SMTP or SMS layer as transport layer. Also, system 200 requires to be implemented into a fully qualified Domain Name Server (“DNS”) server capable of resolving mail traffic. The several components and applications of proxy server 200 have been listed in FIG. 1. It is understood that all modules, applications and databases may be integrated into one computer system 400 or into several separate computer systems which may be servers 310 as part of a remote network 300. By keeping the components of the intermediary computer system modular, the data transmission process, as explained in the following, remains highly independent and flexible.

At step 560, proxy server 200 listens on listener port 25 for incoming messages, which are placed into inbound queue 205. Message after message is retrieved from inbound queue 205, in order to handle high traffic volume and passed onto message validator 210. At step 565, message validator 210 analyzes the transmitted message for MTP encoding, to determine whether the message is intended for the intermediary computer system 200 and for processing in accordance with the system and method of the present invention. When the message validator 210 determines that the incoming message is MTP encoded, it effects priority treatment of the associated session connection by allocating dedicated resources and thereby mimics a circuit-like communication. Further, at the same step 565, message validator 210 analyzes the <start> tag for the properties included, i.e., the length (“1”), the number of pages (“n”), page number (“p”), and serial number (“s”). If there are several messages with the same serial number s, it collates the messages into one object. If the transmission is complete according to the analysis of the <start> tag, at step 570, the message validator 210, via outbound queue 250, sends back an MTP encoded conformation message to the two-way messaging device 10, with the t value set at 3, which causes the MTP stack 27 to flush the transmitted message from memory 15 as explained in step 555. If the transmission is corrupt or incomplete, an MTP encoded message is sent to the two-way messaging device 10 at step 575, with the t value set at 2. As described in FIG. 6, at step 550, the MTP stack 27 will then trigger steps 535 to 545 to be repeated with the modification that the MTP encoded message retrieved from memory 15 of the two-way messaging device 10. When message validator 210 indicates that the message transmission is complete, step 570 is executed as explained above. If the user chose at step 505 to encrypt the message, the encryption module 245 subsequently decrypts the message at step 580 and passes the message on to session module 215. If no encryption was requested, the present invention will directly proceed to step 585.

At step 585, the session module 215 creates a session id for the time of the session of data retrieval and transmission, which is re-transmitted to device 10 via outbound queue 250. The re-transmission of the session id enables the MTP stack 27 at device 10 to distinguish and coordinate possible distinct data requests and transmissions.

In the example, the following MTP encoded message containing the session id and serial id would be transmitted by intermediary computer system 200 to the two-way messaging device 10: <MTP 1.0><start 1=015 n=01 p=01 s=99999 t=0>sessionid=12345</end>.

Also, at step 585, the session module 215 collects the transmitted WIP of device 10, the requested URL or URI, creates a time stamp and passes it onto the WIP/IP mapper 220 along with the session id. This step later facilitates identification and transmission of the respective data packets to the corresponding two-way messaging device 10.

Then, at step 590, the event handler 225 analyzes the body of the message with the embedded data request for the type of data file to be retrieved, i.e., a user may chose to request a Web site, a FTP file, a SQL database value or an email. For each of the different file types 320, a distinct module must be created to retrieve the data. For this reason, event handler 225 passes the result of its data request analysis on to application dispatcher 230. According to the latter information, at step 595, application dispatcher 230 generates or locates in its database an appropriate module for the retrieval of the requested data. In the present example, an HTTP-module is created because the user requested the moviefone Web-site. Yet, if the user requests an email to be retrieved from e.g., the user's remote corporate network 300, an SMTP module is generated. The created module is appended by content fetcher 235 at step 600. There, content fetcher 235 establishes a connection with the appropriate server 310 storing the requested data file 320 and retrieves it by use of the appropriate session module created or located at step 595. In the same step 600, content fetcher 235 parses the requested data file 320 and if necessary transforms it from its designated mark-up language (e.g., HTML) preferably to XML. Some content provider nowadays already use the advanced mark-up language XML, yet, still many data records are marked-up in HTML The data transformation achieved by the content fetcher 235 at step 600 is achieved by use of third party open source software and libraries, such as JTidy, IBM's XML Translator Generator and other document type definitions (“DTDs”), stored on the intermediary computer system 200 or remote servers 310. By way of example, an HTML file is first converted to XHTML and then to XML. Of course, those of skill in the art are well aware of many software components and DTDs which may be used to convert specific mark-up languages into XML. Likewise, it is understood that XML is one of many options for a target mark-up language at step 600, and may be modified in accordance with the development of advanced mark-up languages.

In the present example the XML marked-up data retrieved and if necessary converted by content fetcher 235 may be:

<?xml version=“1.0”?>
<movies>

<theater>

<name>National Amusements Showcase Cinemas Worcester North</name>
<address>135 Brook St</address>
<city>Worcester</city>
<state>MA</state>
<zip>01606</zip>
<phone>5088534000</phone>
<longitude>−718018</longitude>
<latitude>423152</latitude>
<distance>01.1</distance>

</theater>
<theater>

<name>Hoyts Worcester</name>
<address>200 Grove St</address>
<city>Worcester</city>
<state>MA</state>
<zip>01606</zip>
<phone>5088534011</phone>
<longitude></longitude>
<latitude></latitude>
<distance>04</distance>

</theater>
<theater>

<name>Hoyts Westborough Theater</name>
<address>231 Turnpike Road</address>
<city>Westborough</city>
<state>MA</state>
<zip>01581</zip>
<phone>5083663694</phone>
<longitude>−716193</longitude>
<latitude>422846</latitude>
<distance>15.3</distance>

</theater>
<theater>

<name>National Amusements White City Cinema</name>
<address>50 Boston Turnpike Road</address>
<city>Shrewsbury</city>
<state>MA</state>
<zip>01545</zip>
<phone>5087550775</phone>
<longitude>−717531</longitude>
<latitude>422746</latitude>
<distance>10.2</distance>

</theater>
<theater>

<name>Entertainment Cinemas Marlboro</name>
<address>689 Boston Post Road On Route 20</address>
<city>Marlboro</city>
<state>MA</state>
<zip>01752</zip>
<phone>5083038100</phone>
<longitude></longitude>
<latitude></latitude>
<distance>18.3</distance>

</theater>

</movies>

At the same step 600, application dispatcher 230 passes the XML compliant data on to data transformer 240. Since the data retrieved and converted at step 600 may not be suitable for display on two-way messaging device 10, data transformer 240 analyzes the content and mark-up language at step 605. In the same step 605, utilizing a styles-guide stored on the intermediary computer system 200 or remote servers 310, data transformer 240 formats the appended data into a format suitable for display on two-way messaging device 10. By way of example, the well known styles-guide XSL/XSLT may be used to convert XML into a different possible target mark-up language, such as WML. Those of skill in the art are aware of many other styles-guides which may be used in the present invention to achieve data transformation into a mark-up language suitable for display on the client two-way messaging device 10. Also, it is understood that there are many other suitable mark-up languages for display in a two-way messaging device 10.

In the present example, the WML marked-up data transformed by data transformer 240 may be:

<?xml version=&quot;1.0&quot;?>

<!DOCTYPE wml PUBLIC &quot;-//PHONE.COM//DTD WML 1.1//EN&quot;

&quot;http://www.phone.com/dtd/wml11.dtd&quot;>

<wml>

<card title=&quot;WML Example&quot;>

<p mode=&quot;nowrap&quot;>

<select>

<option onpick=&quot;/example&quot;>01.1 - National

Amusements Showcase Cinemas Worcester North - 135 Brook St - Worcester, MA, 01606</option>

<option onpick=&quot;/example&quot;>04 - Hoyts Worcester -

200 Grove St - Worcester, MA, 01606</option>

<option onpick=&quot;/example&quot;>10.2 - National

Amusements White City Cinema - 50 Boston Turnpike Road - Shrewsbury, MA, 01545</option>

<option onpick=&quot;/example&quot;>15.3 - Hoyts

Westborough Theater - 231 Turnpike Road - Westborough, MA, 01581</option>

<option onpick=&quot;/example&quot;>18.3 - Entertainment

Cinemas Marlboro - 689 Boston Post Road On Route 20 - Marlboro, MA, 01752</option>

<select>

</p>

</card>

</wml>

If the user requested encryption in step 505, the encryption module 245 triggers at step 610 encryption of the message and then proceeds to step 615. If no encryption is requested, the present invention continues directly to step 615. There, the retrieved data is appended by the outbound queue 250, which passes a copy on to the cache manager 255. If the user later chooses to navigate back and re-access already displayed data, the cache manager 255 re-submits this data via outbound queue 250.

At step 620, the outbound queue 250 analyzes the length of the retrieved data packet. If the character length of the data packet exceeds 448 characters, outbound queue 250 breaks it down into several 448-character data packages. Then, at step 625, outbound queue 250 assigns the identical serial id to all data packets that conform to the same session. This step later facilitates re-assembly of multi-part data packets at device 10. Subsequently, at step 630 the MTP encoding of each packet is effected by outbound queue 250.

In the present example, the following three messages would be transmitted from intermediary computer system 200 to the two-way messaging device 10:

<MTP 1.0><start l=424 n=03 p=01 s=99990 t=0>
<?xml version=&quot;1.0&quot;?>

<!DOCTYPE wml PUBLIC &quot;-//PHONE.COM//DTD WML 1.1//EN&quot;

&quot;http://www.phone.com/dtd/wml11.dtd&quot;>

<wml>

<card title=&quot;WML Example&quot;>

<p mode=&quot;nowrap&quot;>

<select>

<option onpick=&quot;/example&quot;>01.1 - National

Amusements Showcase Cinemas Worcester North - 135 Brook St - Worcester, MA,
01606</option>

<option onpick=&quot;/example&quot;>04 - Hoyts

Worcester - 200</end>
<MTP 1.0><start 1=433 n=03 p=02 s=99990 t=0>
Grove St - Worcester, MA, 01606</option>

<option onpick=&quot;/example&quot;>10.2 - National

Amusements White City Cinema - 50 Boston Turnpike Road - Shrewsbury, MA, 01545</option>

<option onpick=&quot;/example&quot;>15.3 - Hoyts

Westborough Theater - 231 Turnpike Road - Westborough, MA, 01581</option>

<option onpick=&quot;/example&quot;>18.3 - Entertainment

Cinemas Marlboro - 689 Boston Post Road On Route 20 - Marlboro, MA, 0175</end>
<MTP 1.0><start 1=30 n=03 p=03 s=99990 t=0>
2</option>

</select>

</p>

</card></end>

At step 635, the WIP/IP mapper 220 retrieves the WIP of the two-way messaging device 10 that sent the data request and checks the session id assigned in step 585, in order to verify that the conforming data packets are transmitted. Transmission of the data packet(s) to the respective two-way messaging device 10 is effected by the outbound queue 250 at step 640 via carrier gateway 70 and base station(s) 40. In the preferred embodiment of the present invention, outbound queue 250 may use either SMTP, SMS or if supported by carrier gateway 70 SNPP for the transmission of the MTP encoded data. SNPP, in particular, facilitates the mimicking of circuit-like connections because it supports different priority levels and therefore improves upon the data transmission rate. However, it is understood that the present invention is not limited to the aforementioned transfer protocols, but can be modified according to the emergence of advanced transmission protocols of simple two-way messaging networks 100.

FIG. 8 illustrates the method and process of final data management and display of the transmitted data from intermediary computer system 200 at the two-way messaging device 10. The MTP stack 27 always listens for incoming messages. If a message is received, the MTP stack 27 analyzes at step 645 whether the message is MTP encoded in order to determine whether it is intended for further processing by the MTP stack 27. At step 650, the MTP stack 27 analyzes the <start> tag for completeness of the transmission. If the MTP stack 27 determines that the message is incomplete or corrupt, at step 655, it sends an MTP encoded message to proxy server 200 and triggers a return to step 615 with the modification that the already transformed data packets is retrieved from the cache by cache manger 255 and then re-transmitted in accordance with steps 620 to 650.

In the present example the following MTP encoded message would be transmitted from the two-way messaging device 10 to intermediary computer system 200 in order to request a re-send: <MTP 1.0><start 1=000 n=01 p=01 s=99991 t=2></end>.

This step of the process conforms with the message validation undertaken by message validator 210 at step 575 at the intermediary computer system 200, the server part of the present invention, with the following modification: Based on the assumption that 98% of all transmissions from the intermediary computer system 200 to the two-way messaging device 10 via the simple two-way messaging network 100 are successful, and on account of the limited processing power of two-way messaging devices 10, no confirmation message is sent from two-way messaging device 10 to intermediary computer system 200 in the case of a complete and accurate transmission. Therefore, only when the transmission is incomplete or corrupted, a message will be sent from the two-way messaging device 10 to intermediary computer system 200. If the transmission was complete, the present invention will directly proceed to step 660.

At step 660, the MTP stack 27 gathers all received data packets featuring the identical serial and session id, and collates said packets into one object, so that the whole data packet can be displayed by an application, such as browser 29 in display 12.

In the present example, the following data would be displayed by WML compliant browser 29 in display 12:

| | |
|---|---|
| 1. | 01.1-National Amusements Showcase Cinemas |
| | Worcester North-135 Brook St-Worcester, MA |
| | 01606 |
| 2. | 04-Hoyts Worcester-200 Groove St-Worcester, |
| | MA, 01606 |
| 3. | 10.2-National Amusments White City Cinema-50 |
| | Boston Turnpike Road-Shrewsbury, MA, 01545 |
| 4. | 15.3-Hoyts Westborough Theater-231 Turnpike |
| | Road-Westborough, MA, 01581 |
| 5. | 18.3-Entertainment Cinemas Marlboro-689 |
| | Boston Post Road On Route 20-Marlboro, MA, 01752 |
| go | menu |

When the user decides to end the session and logs off, the MTP stack 27 sends at step 665 an MTP encoded message to the intermediary computer system 200 which causes the cache manager 255 to flush the cache and return the memory resources to the resource pool. Likewise, at step 670, the MTP stack 27 triggers memory 15 to flush the transmitted messages and to return the memory resources to the resource pool. Yet, if the user decides to conduct another data request, at step 675, a return to step 500 is effected and the method and process as explained in FIG. 6 through 8 is repeated until steps 665 and 670 are finally reached.

While the present invention has been described in reference to a preferred embodiment, those of ordinary skill in the art will recognize that various modifications and variations may be made without departure from the scope of the invention. For example, the present invention likewise enables transmission of retrieved and transformed data to other two-way messaging devices 10 using SMTP and MTP as transport layers. Also, the initial trigger event may be sent from remote network(s) 300 to the two-way messaging device, rather than a data request originating with the two-way messaging device. The process and method of data transformation and transmission would then be effected as described in FIG. 7 with the modification that steps 570 through 595 are obsolete. Additionally, even though the preferred embodiment particularly envisions two-way pagers as device(s) 10, device 10 may be substituted by any other mobile device and take advantage of the ease of data transmission using SMTP as a transport layer, while allowing transmission validation and circuit-like connections effected by the MTP stack 27. Last, notwithstanding the fact that the description of the present invention particularly relates to data transformation from XML to WML, the scope of the patent encompasses the transformation of any other mark-up language to such a mark-up language that can be interpreted and displayed by an interactive mobile device.

It is understood that the illustrated embodiment and outlined alternative embodiments have been set forth merely for the purpose of example, and should not be conceived to limit the invention as defined by the following claims. The claims presented below are intended to encompass not only the elements and their combination set forth in the description of the invention, but all equivalent elements performing substantially the same function and achieving substantially the same results. The claims shall therefore both include what is specifically illustrated in the description of the invention, what can be conceived as an conceptual equivalent, and what represents the substantial idea of the present invention.

What is claimed is:

1. A system for providing two-way communication of content between a wireless mobile communication device and a remote computer network, comprising:
a wireless two-way messaging network further comprising:
said wireless communication device;
a basestation in communication with said wireless communication device;
a gateway server in communication with said basestation; and
a network and layer framework for translating said communicated content between said wireless communication device and said basestation; and
an intermediary computer system in communication with said wireless two-way messaging network and said remote computer network.

2. The system of claim 1, wherein said network and layer framework comprises:
a system layer;
an operating system framework layer;
a user interface; and
a Message Transport Protocol stack.

3. The system of claim 2, wherein said user interface comprises a computer network browser.

4. The system of claim 2, wherein said network and layer framework interface further comprises a data encryption module.

5. The system of claim 1, wherein said intermediary computer system further comprises:
a first electronic queue of data communicated from said wireless two-way messaging network to said intermediary computer system;
a plurality of data modules in communication with said first electronic queue;
an event handler in communication with said plurality of data modules;
an application dispatcher in communication with said plurality of data modules and said event handler;
a second electronic queue of data communicated from said intermediary computer system to said wireless two-way messaging network; and
a content fetcher in communication with said application dispatcher and said remote computer network.

6. The system of claim 5, wherein said second queue further comprises means for Message Transport Protocol encoding.

7. The system of claim 5, wherein said plurality of data modules comprises at least one of:
a message validator;
a session module;
a wireless IP/IP mapper database;
a data transformer;
an encryption module; and
a cache manager.

8. A method for providing two-way communication of content between a wireless mobile communication device and a remote computer network via an intermediary computer system, comprising the steps of:
originating a request for data at said wireless mobile communication device and transmitting said data request through a network and layer framework to a two-way wireless messaging network;
transmitting said request for data from said two-way wireless messaging network via a first electronic queue to said intermediary computer system in communication with said remote computer network;
retrieving the requested data from said remote computer network;
placing said retrieved data in a second queue;
transmitting said retrieved data from said second queue to said wireless communication device via said two-way wireless messaging network; and
displaying said retrieved data at said wireless communication device.

9. The method of claim 8, wherein said request for data is a Uniform Resource Locator.

10. The method of claim 8, wherein said wireless communication device includes a stored Wireless EP, and further wherein the step of transmitting said data request through a network and layer framework to a two-way wireless messaging network comprises the steps of:
encoding said data request into Message Transport Protocol;
sending said Message Transport Protocol-encoded data request to one of a short messaging system stack and an email stack; and
transmitting said Message Transport Protocol-encoded data request and said Wireless IP to said intermediary computer system.

11. The method of claim 10, further comprising the steps of:
placing a copy of said Message Transport Protocol-encoded data request in said wireless communication device;
waiting a fixed duration for one of positive receipt confirmation and negative receipt confirmation from said intermediary computer system;
retrieving said copy of said Message Transport Protocol-encoded data request from said wireless communication device in response to said negative receipt confirmation;
transmitting said retrieved copy of said Message Transport Protocol-encoded data request and said Wireless IP to said intermediary computer system; and
removing said copy of said Message Transport Protocol-encoded data request from said wireless communication device in response to said positive receipt confirmation from said intermediary computer system.

12. The method of claim 8, wherein the step of retrieving the requested data from said remote computer network further comprises the steps of:
retrieving said request for data in said first electronic queue;
validating said retrieved request for data for Message Transport Protocol coding and transmission completeness;
analyzing said retrieved request for data to identify type of data requested;
locating a data module suitable for retrieval of said requested data; and
passing said data module to a content fetcher.

13. The method of claim 12, further including the steps of:
transforming said retrieved data to an intermediary markup language; and
transforming said retrieved data to a target markup language.

14. The method of claim 12, wherein said intermediary markup language is Extensible Markup Language.

15. The method of claim 8, wherein said second electronic queue divides said retrieved data into a plurality of data packets.

16. The method of claim 15, further including the step of Message Transport Protocol-encoding each of said plurality of data packets.

17. The method of claim 16, wherein each of said plurality of data packets has a maximum length of 448 characters.

18. The method of claim 17, wherein said step of transmitting said retrieved data from said second electronic queue to said wireless communication device via said two-way wireless messaging network is conducted using one of Short Messaging Service protocol, Simple Mail Transfer Protocol, and Simple Network Paging Protocol.

19. The method of claim 17, further including the step of retrieving a Wireless IP and Session for said retrieved data.

20. The method of claim 8, further including the steps of:
encrypting one of said data request and said retrieved data prior to transmission; and
decrypting said one of said data request and said retrieved data subsequent to transmission.
